(19) United States
(12) Patent Application Publication
(10) Pub. No.: US 2026/0008356 A1
(43) Pub. Date: Jan. 8, 2026

(54) TORQUE CONTROL SYSTEM AND METHOD FOR DRIVE SYSTEM OF ELECTRIC VEHICLE

(71) Applicants: Hyundai Motor Company, Seoul (KR); Kia Corporation, Seoul (KR)

(72) Inventors: Jiwon OH, Hwaseong-Si (KR); Jeong Soo Eo, Hwaseong-Si (KR); Ho Wook Lee, Hwaseong-Si (KR); Tae Woo Lee, Hwaseong-Si (KR)

(73) Assignees: Hyundai Motor Company, Seoul (KR); Kia Corporation, Seoul (KR)

(21) Appl. No.: 18/936,069

(22) Filed: Nov. 4, 2024

(30) Foreign Application Priority Data
Jul. 8, 2024 (KR) 10-2024-0089507

(51) Int. Cl. B60L 15/20

(52) U.S. Cl. CPC B60L 15/20; B60L 2240/423; B60L 2250/28; B60L 2260/28; B60L 2270/145

(57) ABSTRACT

A torque control system of an electric vehicle includes a controller that generates front-wheel and rear-wheel torque commands having torque values distributed from a required torque for vehicle driving, and front-wheel and rear-wheel motors whose operations are controlled according to the front-wheel and rear-wheel torque commands. The controller determines whether there is a change request of a direction of the required torque, determines, in response that there is the change request of the direction of the required torque, the front-wheel and the rear-wheel torque commands determined from the required torque as values for sequential zero-crossing while the required torque determined in real time changes while performing zero-crossing, and determines a time point at which the front-wheel torque command performs zero-crossing and a time point at which the rear-wheel torque command performs zero-crossing based on the required torque determined in real time.

### CROSS-REFERENCE TO RELATED APPLICATION

The present application claims priority to Korean Patent Application No. 10-2024-0089507 filed on Jul. 8, 2024, the present application claims priority to Korean Patent Application No

### BACKGROUND OF THE PRESENT DISCLOSURE

### Field of the Present Disclosure

The present disclosure relates to a torque control system for a drive system of an electric vehicle and a method therefor, and more particularly, to a torque control system for a drive system of an electric vehicle and a method therefor, configured for alleviating backlash of the drive system and reducing backlash vibration, improving drivability of the electric vehicle.

### Description of Related art

In general, a vehicle's drive system generates appropriate torque according to a torque command determined by a driver's driving input value such as an accelerator position sensor value or a brake position sensor value, or by a request of an ADAS (Advanced Driver Assistance System).

Here, in a case where a torque change rate (that is, a torque gradient) is set too large, problems such as driveshaft twist, gear backlash shock, or drivability deterioration due to rapid torque change may occur.

Conversely, in a case where the torque change rate is set too small, it takes excessive time to provide torque required by a driver or an ADAS controller, and an actual vehicle behavior may differ from a driver's intention, causing frustrating responsiveness or dangerous situations.

Accordingly, it may be said that there is a conflict between the degree of reduction of Noise, Vibration, and Harshness (NVH) and the degree of acceleration/deceleration responsiveness due to rapid torque change in the vehicle.

In this regard, in mass-produced vehicles, to generate an optimal drive system torque command capable of solving the above-mentioned conflict problem, gradient limits and filters that use various conditions as factors have been used.

Furthermore, in an electrified vehicle that utilizes a motor as a drive source or a part thereof, active feedback torque correction control capable of suppressing vibration that has already occurred using the motor may be applied.

However, no matter how advanced backlash post-correction control is, it is difficult to suppress the problem of low responsiveness, which inevitably occurs chronically due to characteristics of hardware. Furthermore, in an electric vehicle with few vibration damping elements in a drive system, NVH issues due to backlash frequently occur.

A method of generating a model speed of a driveshaft using a disturbance observer and reducing vibration using a difference between the model speed of the driveshaft and an actual speed is generally known. Furthermore, a method of determining the model speed based on a wheel speed instead of the disturbance observer is generally known.

Furthermore, a method of generating a model speed of a motor using an input torque model and reducing vibration using a difference between the model speed of the motor and an actual speed (measured speed) is generally known.

Furthermore, a method of estimating a speed of a drive system using a torque model and determining a gradient of a torque command using a difference between the estimated speed and an actual speed of the drive system is generally known.

However, all of the above-mentioned related arts merely present a torque post-correction method for reducing and suppressing vibration occurring in the drive system, and do not present a torque distribution method and a torque correction method based thereon capable of suppressing or preventing vibration.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a torque control system for a drive system and a method therefor, configured for alleviating backlash of the drive system in an electric vehicle and reducing backlash vibration, improving drivability of the vehicle.

In one aspect, the present disclosure provides a torque control system for a drive system of an electric vehicle including a controller that generates a front-wheel torque command and a rear-wheel torque command including torque values distributed from a required torque for vehicle driving, a front-wheel motor, wherein operation of the front-wheel motor is controlled according to the front-wheel torque command generated and output by the controller, and a rear-wheel motor, wherein operation of the front-wheel motor is controlled according to the rear-wheel torque command generated and output by the controller, in which the controller is configured to determine whether there is a change request of a direction of the required torque for the vehicle driving, is configured to determine, in response that the controller concludes that there is the change request of the direction of the required torque, the front-wheel torque command and the rear-wheel torque command determined from the required torque as values for sequential zero-crossing while the required torque determined in real time changes while performing zero-crossing of passing through 0 torque for direction change, and is configured to determine a time point at which the front-wheel torque command performs the zero-crossing and a time point at which the rear-wheel torque command performs the zero-crossing based on the required torque determined in real time.

In an exemplary embodiment of the present disclosure, the controller may be configured to determine the front-wheel torque command and the rear-wheel torque command determined from the required torque while the required torque changes, as values so that a torque sum of the front-wheel torque command and the rear-wheel torque command satisfies the required torque.

In another exemplary embodiment of the present disclosure, the controller may perform torque correction for limiting a change rate of the front-wheel torque command to a preset first maximum allowable change rate in the zero-crossing of the front-wheel torque command, and perform torque correction for limiting a change rate of the rear-wheel torque command to a preset second maximum allowable change rate in the zero-crossing of the rear-wheel torque command.

In yet another exemplary embodiment of the present disclosure, the controller may perform, while performing the torque correction for limiting the change rate of the front-wheel torque command to the preset first maximum allowable change rate, torque compensation for the rear-wheel torque command distributed from the required torque so that a sum of the front-wheel torque command, the change rate of which is limited, and the rear-wheel torque command distributed from the required torque satisfies the required torque.

In yet another exemplary embodiment of the present disclosure, the controller may perform, while performing the torque correction for limiting the change rate of the rear-wheel torque command to the preset second maximum allowable change rate, torque compensation for the front-wheel torque command distributed from the required torque so that a sum of the rear-wheel torque command, the change rate of which is limited, and the front-wheel torque command distributed from the required torque satisfies the required torque.

In still yet another exemplary embodiment of the present disclosure, the controller may set a front-wheel torque distribution rate and a rear-wheel torque distribution rate as values that vary depending on the required torque. In response that the front-wheel torque distribution rate corresponding to the required torque determined in real time is 0, a torque value of the front-wheel torque command may become 0 and the zero-crossing of passing through 0 torque may be performed in the front-wheel torque command, and in response that the rear-wheel torque distribution rate corresponding to the required torque determined in real time is 0, a torque value of the rear-wheel torque command may become 0 and the zero-crossing passing through 0 torque may be performed in the rear-wheel torque command.

In a further exemplary embodiment of the present disclosure, in response that the required torque determined in real time gradually increases from torque in a vehicle deceleration direction and switches to torque in a vehicle acceleration direction, the controller may first perform the zero-crossing of the rear-wheel torque command, and then perform the zero-crossing of the front-wheel torque command.

In another further exemplary embodiment of the present disclosure, the controller may set a first threshold, which is a torque with a negative (−) value, as the torque in the vehicle deceleration direction, and set a second threshold, which is a torque with a positive (+) value, as the torque in the vehicle acceleration direction, start and perform control for the zero-crossing of the rear-wheel torque command at a time point at which the required torque increases from the torque in the vehicle deceleration direction and reaches the first threshold, and start and perform control for the zero-crossing of the front-wheel torque command at a time point at which the required torque switches to the torque in the vehicle acceleration direction and increases to reach the second threshold.

In yet another further exemplary embodiment of the present disclosure, in response that the required torque determined in real time gradually decreases from torque in a vehicle acceleration direction and switches to torque in a vehicle deceleration direction, the controller may first perform the zero-crossing of the front-wheel torque command, and then perform the zero-crossing of the rear-wheel torque command.

In yet another further exemplary embodiment of the present disclosure, the controller may set a third threshold, which is a torque with a positive (+) value, as the torque in the vehicle acceleration direction, and set a fourth threshold, which is a torque with a negative (−) value, as the torque in the vehicle deceleration direction, start and perform control for the zero-crossing of the front-wheel torque command at a time point at which the required torque decreases from the torque in the vehicle acceleration direction and reaches the third threshold, and start and perform control for the zero-crossing of the rear-wheel torque command at a time point at which the required torque switches to the torque in the vehicle deceleration direction and decreases to reach the fourth threshold.

In still yet another further exemplary embodiment of the present disclosure, in response that the required torque determined in real time increases or decreases linearly, after a preset time elapses after the zero-crossing of one of the front-wheel torque command and the rear-wheel torque command is completed, the controller may perform the zero-crossing of the other of the front-wheel torque command and the rear-wheel torque command.

In another aspect, the present disclosure provides a torque control method for a drive system of an electric vehicle, including determining whether there is a change request of a direction of required torque for vehicle driving, by a controller, determining, in response that the controller concludes that there is the change request of the direction of the required torque, a front-wheel torque command and a rear-wheel torque command including torque values distributed from the required torque determined in real time while the required torque determined in real time changes while performing zero-crossing of passing through 0 torque to change the direction, by the controller, and controlling operations of a front-wheel motor and a rear-wheel motor according to the determined front-wheel torque command and rear-wheel torque command, by the controller, in which the controller is configured to determine the front-wheel torque command and the rear-wheel torque command determined from the required torque as values for sequential zero-crossing while the required torque changes while performing the zero-crossing for direction change, and determine a time point at which the front-wheel torque command performs the zero-crossing and a time point at which the rear-wheel torque command performs the zero-crossing based on the required torque determined in real time.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing a configuration of a system that is configured to perform a drive system torque control process according to an exemplary embodiment of the present disclosure;

FIG. 2 is a diagram showing sequential torque direction change of a front-wheel torque command and a rear-wheel torque command according to an exemplary embodiment of the present disclosure;

FIG. 3 is a diagram illustrating typical front and rear-wheel torque control states;

FIG. 4 is a diagram illustrating an example of sequential torque direction change of a front-wheel torque command and a rear-wheel torque command and gradient limit correction in zero-crossing according to an exemplary embodiment of the present disclosure;

FIG. 5 is a diagram showing an example of torque correction values for reducing backlash shock and torque correction using the torque correction values according to an exemplary embodiment of the present disclosure; and

FIG. 6 is a diagram illustrating a method of determining zero-crossing time points of a front-wheel torque command and a rear-wheel torque command based on required torque according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, reference will be made in detail to various embodiments of the present disclosure, examples of which are illustrated in the accompanying drawings and described below. The following specific structural and functional descriptions of embodiments of the present disclosure are merely illustrative for describing the embodiments according to an exemplary embodiment of the present disclosure, and the exemplary embodiments of the present disclosure may be implemented in various other forms. The present description is not intended to limit the present disclosure to the exemplary embodiments of the present disclosure, and various alternatives, modifications, equivalents and other embodiments should be interpreted as being within the spirit and scope of the present disclosure.

It will be understood that, although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the exemplary embodiments of the present disclosure.

Furthermore, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other words used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like parts. The terminology used herein is for describing various exemplary embodiments only and is not intended to limit exemplary embodiments of the present disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure provides a method for generating a motor torque command and performing drive system torque control, configured for minimizing influence on drivability due to a drive system backlash in an electric vehicle including two or more individual drive motors.

In an exemplary embodiment of the present disclosure, in a case where there is a change request of a direction of required torque, control is performed so that a torque direction of a front-wheel drive system and a torque direction of a rear-wheel drive system are sequentially changed, and torque of the front-wheel drive system and torque of the rear-wheel drive system sequentially pass through a backlash band (backlash occurrence torque section).

On the other hand, in typical backlash shock reduction control, in a case where there is a change request of a direction of required torque, control is performed so that a torque direction of a front-wheel drive system and a torque direction of a rear-wheel drive system are changed simultaneously, and in particular, torque of the front-wheel drive system and torque of the rear-wheel drive system achieve zero-crossing while passing through a backlash band at the same time.

Unlike the typical backlash shock reduction control method in which the torque of the front-wheel drive system and the torque of the rear-wheel drive system pass through the backlash band simultaneously, in an exemplary embodiment of the present disclosure, the torque of the front-wheel drive system (referred to as “front-wheel torque”) and the torque of the rear-wheel drive system (referred to as “rear-wheel torque”) sequentially pass through the backlash band.

In the exemplary embodiments of the present disclosure, in a case where the torque of one of the front-wheel drive system and the rear-wheel drive system performs zero-crossing while passing through the backlash band, torque compensation control is performed on the other drive system to offset the effect, making it possible to prevent backlash of the drive system from affecting the overall acceleration of the vehicle.

Since the sequential torque direction change according to an exemplary embodiment of the present disclosure needs more procedures than the typical simultaneous torque direction change, there may be a limit to securing acceleration/deceleration responsiveness.

However, in a case where simultaneous torque direction change is performed, problems such as vibration and reaction delay appear at the moment when the torque direction change occurs, but in a case where sequential torque direction change is performed, mutual torque compensation between the front and rear wheels may be achieved. Thus, the total length and time of a transient section in which acceleration/deceleration response delay appears may be similar or rather shortened compared with the related art.

Furthermore, in a case where control for ensuring additional mutual torque compensation between the front and rear wheels is applied, it is possible to solve a two-stage acceleration/deceleration feeling, which is one of problems that could not be overcome in the related art.

In an exemplary embodiment of the present disclosure, the backlash band may be defined as a torque band where backlash may occur in the vehicle drive system. The vehicle drive system includes drive elements such as a drive unit that drives a vehicle, drive wheels, a driveshaft, a reducer, a differential, and an axle between the drive unit and the drive wheels.

Since problems due to the backlash in the vehicle drive system mainly occur only in a torque band close to 0, it may be said that the torque band close to 0 may be the backlash band where the backlash problems may occur.

In an exemplary embodiment of the present disclosure, the backlash band may include a backlash band of the front-wheel drive system, which is a torque band where the backlash may occur in the front-wheel drive system, and a backlash band of the rear-wheel drive system, which is a torque band where the backlash may occur in the rear-wheel drive system.

In an exemplary embodiment of the present disclosure, the backlash band of the front-wheel drive system and the backlash band of the rear-wheel drive system may be respectively set to a torque range including a lower limit threshold, which is a negative (−) value, and an upper limit threshold, which is a positive (+) value.

That is, the backlash band may be set to a torque range including 0, and a backlash state may occur in a case where an input torque applied to the drive system from the motor, which is a drive unit, enters the set backlash band.

Here, the backlash refers to a gap that exists between engaged teeth of two gears. Between the two engaged gears, the backlash may cause vibration or noise as the gear teeth strike each other, and in the worst case, the backlash may cause damage to the gears.

In a case where torque is continuously applied in a specific direction, since one of the two engaged gears continues to transmit power in the same direction to the other, the teeth of the two engaged gears remain aligned and engaged in the specific direction, and thus, the backlash problems do not occur.

However, in a case where the direction of the torque changes, the power transmitting direction changes, and the gear teeth are aligned in a reverse direction after experiencing the backlash. Here, after the alignment in the reverse direction is achieved, since the engagement of the gears is not released again while transmitting power in the same direction, the backlash problems do not occur.

However, at the moment when the power transmitting direction changes again, since the engagement between the gears is released and then achieved again after passing through the backlash gap, the backlash problems occur.

In the typical backlash shock reduction control, while the direction of the drive system torque is changed and the drive system torque passes through the backlash band, the torque of the front-wheel drive system and the torque of the rear-wheel drive system pass through the backlash band at the same time.

In the instant case, by performing control for limiting a change rate (gradient) of a torque command of the front-wheel drive system (front-wheel torque command) and a change rate of a torque command of the rear-wheel drive system (rear-wheel torque command), it is possible to prevent the torque commands from rapidly increasing. The backlash control is performed to ensure smooth torque change within the backlash band for the front-wheel torque command and the rear-wheel torque command.

To the present end, a maximum allowable change rate in the backlash band for the front-wheel torque command and the rear-wheel torque command may be set to such a small value that does not cause the backlash shock. Accordingly, while the front-wheel torque command and the rear-wheel torque command change and pass through the backlash band, the front-wheel torque command and the rear-wheel torque command may be determined as values that change smoothly according to the maximum allowable change rate (gradient) of the small value.

That is, while passing through the backlash band, the change rates of the front-wheel torque command and the rear-wheel torque command are limited to values equal to or smaller than the maximum allowable change rate, respectively, so that the change rates of the front-wheel torque command and the rear-wheel torque command do not exceed the maximum allowable change rate.

Furthermore, the front-wheel torque command and the rear-wheel torque command after passing through the backlash band are determined as values that satisfy the torque distributed through the normal front-wheel and rear-wheel torque distribution process.

On the other hand, in an exemplary embodiment of the present disclosure, by allowing the front-wheel torque command and the rear-wheel torque command to sequentially pass through the backlash band, and performing, while one of the front-wheel torque command and the rear-wheel torque command is passing through the backlash band, torque compensation control for offsetting the effect on the other of the front-wheel torque command and the rear-wheel torque command, it is possible to allow the sum of the front-wheel torque command and the rear-wheel torque command to constantly satisfy the required torque, preventing the backlash of the drive system from affecting the overall acceleration of the vehicle.

Hereinafter, a torque control system for a drive system of an electric vehicle and a method therefor according to an exemplary embodiment of the present disclosure will be described in detail.

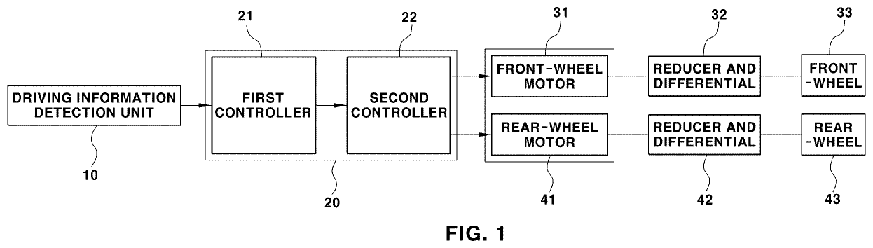

FIG. 1 is a block diagram showing a configuration of a system that is configured to perform a drive system torque control process according to an exemplary embodiment of the present disclosure. The configuration of the system is described as follows.

The exemplary embodiment of the present disclosure may be applied to a vehicle in which front wheels 33 and rear wheels 43 are driven by independent drive units. The exemplary embodiment of the present disclosure may be applied to a vehicle provided with a front-wheel drive unit that applies torque to the front wheels 33 and a rear-wheel drive unit that applies torque to the rear wheels 43. Here, the front-wheel 33 and the rear-wheel 43 are drive wheels connected to the respective drive units to allow power transmission.

Furthermore, the exemplary embodiment of the present disclosure may be applied to a vehicle in which both the front-wheel drive unit and the rear-wheel drive unit are motors. In the following description, a motor 31, which is the front-wheel drive unit, will be referred to as a “front-wheel motor”, and a motor 41, which is a rear-wheel drive unit, will be referred to as a “rear-wheel motor”.

As shown in the figure, the front-wheel motor 31 is connected for power transmission to the front wheels 33 through a reducer and differential 32, and the rear-wheel motor 41 is connected for power transmission to the rear wheels 43 through a reducer and differential 42.

In the following description, a front-wheel torque command and a rear-wheel torque command are axle torque (front axle torque and rear axle torque) commands, which refer to torque commands for the respective motors 31 and 41, that is, a front-wheel motor torque command which is a torque command for the front-wheel motor 31 and a rear-wheel motor torque command which is a torque command for the rear-wheel motor 41, respectively.

In an exemplary embodiment of the present disclosure, among the motor torques, torque in a vehicle acceleration direction and torque in a motor driving direction are defined as positive (+) direction torque, that is, torque with a positive (+) value. Furthermore, among the motor torques, torque in a vehicle deceleration direction and torque in a motor regenerative direction are defined as negative (−) direction torque, that is, torque with a negative (−) value.

In a case where the torque values of the front-wheel torque command and rear-wheel torque command are positive (+) values, the commands are driving torque commands for the relevant motors, and in a case where the torque values of the front-wheel torque command and rear-wheel torque command are negative (−) values, the commands are regenerative braking torque commands for the relevant motors. The torque value of each command becomes the size of the torque to be generated by the relevant motor according to the command.

In an exemplary embodiment of the present disclosure, the drive system of the vehicle includes the front-wheel drive system and the rear-wheel drive system, and each of the front-wheel drive system and the rear-wheel drive system includes drive elements such as the motor that drives the vehicle and the drive wheels, the driveshaft between the motor and the drive wheels, the reducer and differential, and the axle.

The front-wheel drive system includes the front-wheel motor 31, the front wheels 33, the driveshaft between the front-wheel motor 31 and the front wheels 33, the reducer and differential 32, the axle, and the rear-wheel drive system includes the rear-wheel motor 41, the rear wheels 43, the driveshaft between the rear-wheel motor 41 and the rear wheels 43, the reducer and differential 42, and the axle.

In each drive system, torque output from the front-wheel motor 31 and the rear-wheel motor 41 may be transmitted to the front wheels 33 and the rear wheels 43 through the drive elements such as the driveshaft, the reducers and differentials 32 and 42, and the axles.

Furthermore, although not shown in FIG. 1, a battery is connected to the front-wheel motor 31 and the rear-wheel motor 41 via an inverter to enable charging and discharging. The inverter may include a front-wheel inverter for driving and controlling the front-wheel motor 31 and a rear-wheel inverter for driving and controlling the rear-wheel motor 41.

In an electric vehicle, operations (driving and regenerative braking) of the front-wheel motor 31 and the rear-wheel motor 41 are controlled according to torque commands generated by a controller 20. The controller 20 is configured to determine required torque for driving the vehicle based on vehicle driving information obtained by a driving information detection unit 10, or the like, and is configured to determine front-wheel torque and rear-wheel torque distributed to the front and rear wheels from the required torque.

Accordingly, the controller 20 utilizes the determined front-wheel torque and rear-wheel torque as command values to generate and output torque commands for the respective motors, that is, a front-wheel torque command and a rear-wheel torque command, which are torque commands for the respective motors to generate the front-wheel torque and the rear-wheel torque.

Furthermore, the controller 20 is configured to control the operations of the front-wheel motor 31 and the rear-wheel motor 41 through an inverter based on the front-wheel torque command and the rear-wheel torque command. As described above, in a case where the torque values of the front-wheel torque command and the rear-wheel torque command are the positive (+) direction torque (positive value torque), they may be defined as driving torque commands, which are torque commands in the vehicle acceleration direction and the driving direction, and in a case where the torque values of the front-wheel torque command and the rear-wheel torque command are the negative (−) direction torque (negative value torque), they may be defined as regenerative braking torque commands, which are torque commands in the vehicle deceleration direction and the regenerative direction thereof.

In an exemplary embodiment of the present disclosure, the controller 20 may include a first controller 21 that is configured to determine the required torque for the vehicle driving based on vehicle driving information such as driver's driving input values detected by the driving information detection unit 10 or receives the vehicle driving information from another controller such as an ADAS (Advanced Driver Assistance System) controller and generates and outputs the front-wheel torque command and the rear-wheel torque command, which are the torque commands for the respective motors (respective axles), based on the required torque, and a second controller 22 that is configured to control the operations of the front-wheel motor 31 and the rear-wheel motor 41 according to the front-wheel torque command and the rear-wheel torque command output from the first controller 21.

The first controller 21 may be a vehicle control unit (VCU) that is configured to determine and generates a torque command necessary for vehicle driving in a typical vehicle. In a general drive mode, since a method for determining required torque for vehicle driving from vehicle driving information and determining a torque command for controlling torque of a drive system including a motor is well-known in the art, a detailed description thereof will be omitted.

In a case where the front-wheel torque command and the rear-wheel torque command are output from the first controller 21, the second controller 22 receives the torque commands, and is configured to control the operations of the front-wheel motor 31 and the rear-wheel motor 41 through the front-wheel inverter and the rear-wheel inverter.

As a result, the torque output from the front-wheel motor 31 is applied to the front wheels 33 through the reducer and differential 32 of the front-wheel drive system, and the torque output from the rear-wheel motor 41 is applied to the rear wheels 43 through the reducer and differential 42 of the rear-wheel drive system.

The second controller 22 may be a typical motor control unit (MCU) that is configured to control an operation of a drive motor through an inverter according to a torque command output from the vehicle control unit (VCU) in the electric vehicle.

In an exemplary embodiment of the present disclosure, the vehicle driving information input to the controller 20 is information indicating a vehicle driving status, such as a driver's driving input value, and may include sensor detection information which is detected by the driving information detection unit 10 and is input to the controller 20 through a vehicle network.

The driving information detection unit 10 may include an accelerator position sensor (APS) which is configured to detect a driver's accelerator position sensor value (APS value, %), a speed sensor which is configured to detect a drive system speed, and a sensor which is configured to detect a vehicle speed.

Here, the drive system speed may be a rotation speed of a drive element which is present on a power transmission path from the front-wheel motor 31 or the rear-wheel motor 41 to the corresponding wheels 33 and 43 in the front-wheel drive system or the rear-wheel drive system.

For example, the drive system speed may be a rotation speed of the front-wheel motor 31 and the rear-wheel motor 41, or a rotation speed (wheel speed) of the drive wheels 33 and 43. The speed sensor which is configured to detect the drive system speed may be a sensor which is configured to detect the rotation speed of each of the motors 31 and 41, which may be a normal resolver which is configured to detect a rotor position of the motor. Alternatively, the speed sensor may be a normal wheel speed sensor which is configured to detect the rotation speed (wheel speed) of the drive wheels 33 and 43.

The sensor which is configured to detect the vehicle speed may also be a wheel speed sensor. Since a method of obtaining vehicle speed information from a signal of the wheel speed sensor is well-known in the art, a detailed description thereof will be omitted.

As the vehicle driving information for determining and generating the required torque and torque command in the controller 20, a driver's accelerator position sensor value (APS value, %), rotation speeds of the motors 31 and 41, rotation speeds of the drive wheels 33 and 43, a vehicle speed, or the like, which is detected by the driving information detection unit 10, may be selectively used.

Here, in a broad sense, the vehicle driving information may include information determined by the controller 20 itself, and furthermore, may include information (for example, required torque information) input to the controller 20 from another controller (for example, ADAS controller) in the vehicle through the vehicle network.

In the above description, the control subject includes the first controller 21 and the second controller 22, but the torque control process according to an exemplary embodiment of the present disclosure may be performed by a single integrated control element instead of the above-described plurality of controllers.

In the present specification, the plurality of controllers 21 and 22 and the single integrated control element may be collectively referred to as the controller 20, and the torque control process according to an exemplary embodiment of the present disclosure may be performed by the controller 20. In the following description, the controller 20 collectively refers to the first controller 21 and the second controller 22 of FIG. 1.

The configuration of the system that is configured to perform the drive system torque control process according to an exemplary embodiment of the present disclosure has been described. Hereinafter, the drive system torque control process performed by the above-described system will be described in detail.

In an exemplary embodiment of the present disclosure, the controller 20 is configured to determine required torque for vehicle driving from real-time vehicle driving information detected by the driving information detection unit 10, and then is configured to perform front-wheel and rear-wheel torque distribution for following the determined required torque.

In the front-wheel and rear-wheel torque distribution process, the controller 20 is configured to determine the front-wheel torque command and the rear-wheel torque command so that a torque sum of the front-wheel torque command and the rear-wheel torque command (a sum of distributed front-wheel and rear-wheel torque values) is a value for following the required torque.

The controller 20 may distribute required torque received from another controller such as an ADAS controller, instead of the required torque determined by the controller 20 from the vehicle driving information, into front-wheel torque and rear-wheel torque.

Since a method of determining the required torque from the vehicle driving information indicating the driver's driving input value such as an accelerator position sensor value or brake position sensor value, and the vehicle speed is well-known, a detailed description thereof will be omitted.

In a case where the driver tips in an accelerator or tips out the accelerator in the tip-in state, the required torque may switch from vehicle deceleration direction torque to vehicle acceleration direction torque, or vice versa. In an exemplary embodiment of the present disclosure, the required torque includes the vehicle acceleration direction torque and the vehicle deceleration direction torque.

In a case where the direction of the required torque is reversed, the directions of the front-wheel torque and the rear-wheel torque may also be reversed. In the exemplary embodiment of the present disclosure, in a case where there is a change request of the direction of the required torque and a zero-crossing request, the controller 20 sequentially changes the direction of the front-wheel torque (command) and the direction of the rear-wheel torque (command).

In an exemplary embodiment of the present disclosure, in a case where the direction of the required torque is to be changed in the opposite direction, that is, in a case where there is a change request of the direction of the required torque, the controller 20 is configured to perform control so that the front-wheel torque and the rear-wheel torque sequentially pass through the backlash band (sequential torque direction change).

Here, the fact that the front-wheel torque and the rear-wheel torque are controlled to sequentially pass through the backlash band means that the respective torque commands for controlling the front-wheel motor 31 and the rear-wheel motor 41, that is, the front-wheel torque command and the rear-wheel torque command are determined to sequentially pass through the backlash band. In the instant case, the two torque commands sequentially perform zero-crossing.

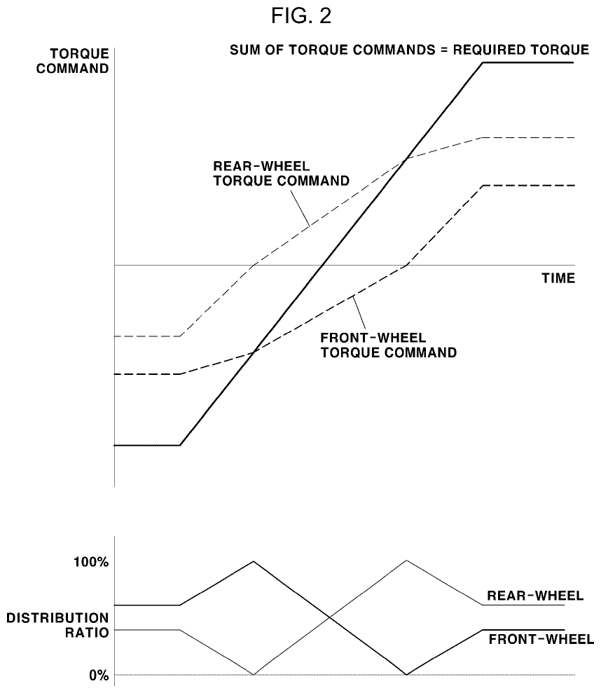

FIG. 2 is a diagram showing sequential torque direction change and zero-crossing of a front-wheel torque command and a rear-wheel torque command in an exemplary embodiment of the present disclosure. A lower portion of FIG. 2 illustrates a torque distribution ratio for the front and rear wheels.

Referring to the lower portion of FIG. 2, it may be understood that, in a case where control is performed for the sequential torque direction change, the torque distribution ratio for the front and rear wheels varies in real time.

In an exemplary embodiment of the present disclosure, in a case where it is determined that there is a change request of the direction of the required torque from the vehicle driving information such as an accelerator position sensor value, the controller 20 sequentially determines the front-wheel torque command and the rear-wheel torque command determined from the required torque while the required torque determined changes in real time while performing zero-crossing of passing through 0 torque for the direction change, so that the front-wheel torque and rear-wheel torque sequentially pass through the backlash band.

Here, the direction change of the rear-wheel torque command may be performed first and then the direction change of the front-wheel torque command may be performed. The respective torque commands in the direction change of the rear-wheel torque command and the front-wheel torque command pass through the backlash band and perform zero-crossing.

In the exemplary embodiment of the present disclosure, the direction change of the front-wheel torque and the rear-wheel torque is performed through the sequential passage of the front-wheel torque and the rear-wheel torque through the backlash band, and the sequential passage of the front-wheel torque (command) and the rear-wheel torque (command) through the backlash band includes a process of sequentially performing the zero-crossing of the front-wheel torque and the zero-crossing of the rear-wheel torque.

In an exemplary embodiment of the present disclosure, in a case where it is determined that there is the change request of the direction of the required torque, the controller 20 is configured to perform control so that the front-wheel torque and the rear-wheel torque are distributed at a torque distribution ratio corresponding to the real-time required torque to sequentially pass through the backlash band.

To the present end, the torque distribution ratio may be set in advance as a value according to the required torque in the controller 20. Here, the torque distribution ratio may be set to a value that varies depending on the required torque.

In the present way, in the exemplary embodiment of the present disclosure, the torque distribution ratio for the front and rear wheels may be dynamically changed and adjusted according to the value of the required torque (entire torque command which is a torque command before distribution, sum of front and rear-wheel torque commands after distribution), so that zero-crossing time points of the front and rear wheels may be dualized.

In the exemplary embodiment of the present disclosure, as in the example of FIG. 2, the torque distribution ratio may be set as a value so that the ratio of a torque distribution rate of the front wheels and a torque distribution rate of the rear wheels according to the required torque becomes the torque distribution ratio, and so that the torque distribution rate of the front wheels and the torque distribution rate of the rear wheels correspond to the required torque.

Here, the torque distribution rate of the front wheels and the torque distribution rate of the rear wheels may each be a percentage value, and may be set so that the sum of the torque distribution rate of the front wheels and the torque distribution rate of the rear wheels is 100%.

As described above, in the exemplary embodiment of the present disclosure, as the front and rear-wheel torque distribution ratio is set as a variable value corresponding to the required torque, it is possible to perform zero-crossing for one of the front-wheel torque and the rear-wheel torque in a section where large required torque is not necessary to use only one of the front-wheel motor 31 and the rear-wheel motor 41 at the zero-crossing time point, and to use both the motor torques in a section where large required torque is necessary.

Referring to the lower portion of FIG. 2, an example in which the torque distribution rate of the front wheels and the torque distribution rate of the rear wheels are set as values corresponding to the required torque, which will be described as follows.

In a case where the required torque is in a negative (−) direction torque band, the front-wheel torque distribution rate corresponding to required torque of a first set value may be set to 100%, which is a maximum value, and the rear-wheel torque distribution rate corresponding to the required torque of the first set value may be set to 0%, which is a minimum value.

Furthermore, as an absolute value of the required torque linearly decreases to the first set value, the front-wheel torque distribution rate may be set as a value that linearly increases, and the rear-wheel torque distribution rate may be set as a value that linearly decreases.

Furthermore, in a case where the required torque is in the negative (−) direction torque band, as the absolute value of the required torque linearly decreases from the first set value until it becomes 0, the front-wheel torque distribution rate decreases linearly. As a result, the rear-wheel torque distribution rate may be set as a value that increases linearly. Furthermore, in a case where the required torque is a value of 0, the front-wheel torque distribution rate and the rear-wheel torque distribution rate may be set as the same value.

Similarly, in a case where the required torque is in a positive (+) direction torque band, the rear-wheel torque distribution rate corresponding to required torque of a second set value may be set to 100%, which is a maximum value, and the front-wheel torque distribution rate corresponding to the required torque of the second set value may be set to 0%, which is a minimum value.

Furthermore, as the required torque linearly increases to the second set value, the rear-wheel torque distribution rate may be set as a value that linearly increases, and the front-wheel torque distribution rate may be set as a value that linearly decreases.

Furthermore, in a case where the required torque is in the positive (+) direction torque band, as the required torque linearly increases from the second set value, the front-wheel torque distribution rate increases linearly. As a result, the rear-wheel torque distribution rate may be set as a value that decreases linearly.

Accordingly, in a case where the front-wheel torque distribution rate corresponding to the required torque determined in real time is 0% (torque distribution ratio of 0), a torque value of the front-wheel torque command becomes 0, and the controller 20 may perform zero-crossing so that the front-wheel torque command passes through 0 torque.

Similarly, in a case where the rear-wheel torque distribution rate corresponding to the required torque determined in real time is 0% (torque distribution ratio of 0), a torque value of the rear-wheel torque command becomes 0, and the controller 20 may perform zero-crossing so that the rear-wheel torque command passes through 0 torque.

Furthermore, in the exemplary embodiment of the present disclosure, in a case where the required torque, that is, the entire torque command which is the torque command before distribution (=the sum of the front and rear-wheel torque commands after distribution) gradually increases from vehicle deceleration and switches to vehicle acceleration, the controller 20 first may perform zero-crossing of the rear-wheel torque command, and then perform zero-crossing of the front-wheel torque command.

Since the vehicle load moves rearward when the vehicle accelerates, it is reasonable to use the grip of the rear wheels first based on a vertical load distribution ratio. Accordingly, by first performing zero-crossing of the rear-wheel torque command, it is possible to secure the vehicle's acceleration torque.

Furthermore, in a case where the required torque gradually decreases from vehicle acceleration and switches to vehicle deceleration, the controller 20 may first perform zero-crossing of the front-wheel torque command, and then perform zero-crossing of the rear-wheel torque command.

Since the vehicle load moves forward when the vehicle decelerates, it is reasonable to use the grip of the front wheels first based on the vertical load distribution ratio. Accordingly, by first performing zero-crossing of the front-wheel torque command, it is possible to secure the vehicle's acceleration torque.

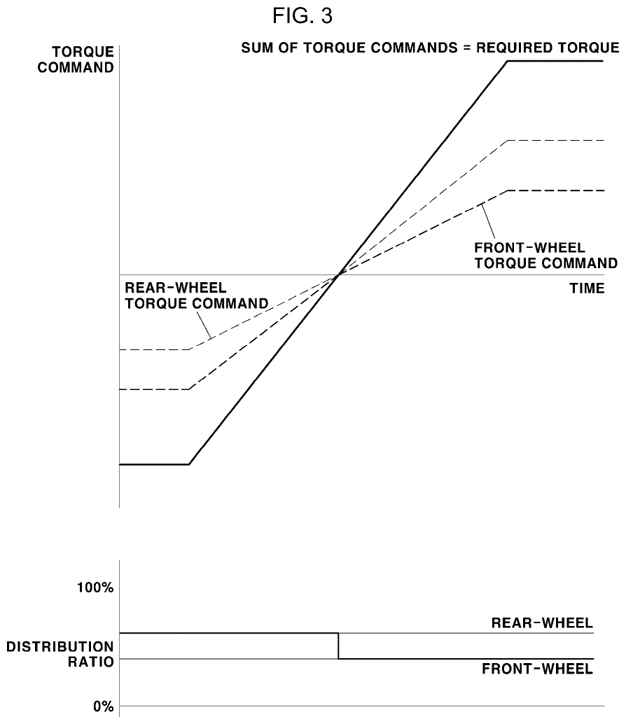

FIG. 3 is a diagram illustrating typical front and rear-wheel torque control states, for ease of understanding of the present disclosure. As shown in FIG. 3, generally, in a case where there is a change request of the direction of the required torque, the front-wheel torque and the rear-wheel torque simultaneously pass through the backlash band and simultaneously perform zero-crossing. Here, a constant value, rather than a variable value as shown in FIG. 2, may be used as a torque distribution ratio for the front and rear wheels.

In a case where the front-wheel torque command and the rear-wheel torque command perform zero-crossing at the same time as general, backlash inevitably occurs due to the characteristics of the drive system hardware in a section where the torque direction changes.

Here, the torque transmission of the drive system is stopped for a while due to the backlash, resulting in acceleration/deceleration discontinuities and drivability shock. To reduce such a problem, it is necessary to perform backlash shock reduction control for limiting a change rate (gradient) of each torque command while the torque command passes through the backlash band. However, in a case where the change rate of the torque command is limited in the present way, the responsiveness of a vehicle behavior deteriorates.

On the other hand, in an exemplary embodiment of the present disclosure, the front-wheel torque command and the rear-wheel torque command sequentially perform zero-crossing, and in the instant case, while the torque command of one drive system passes through the backlash band, which is a direction change section, the torque may be compensated for in the other drive system. Thus, it is possible to solve the problem of the vehicle responsiveness.

As another exemplary embodiment of the present disclosure, in the sequential zero-crossing process, backlash shock reduction control may be performed to limit the change rate (gradient) of the front-wheel torque command to a predetermined value when the front-wheel torque command passes through the backlash band and performs zero-crossing, and to limit the change rate of the rear-wheel torque command to a predetermined value when the rear-wheel torque command passes through the backlash band and performs zero-crossing.

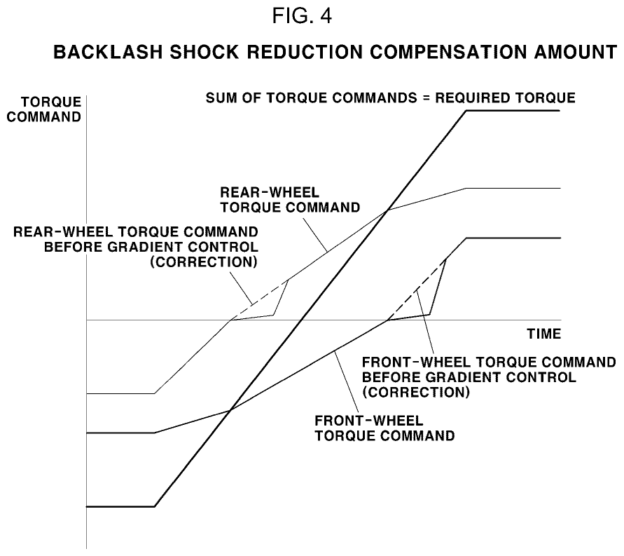

FIG. 4 is a diagram illustrating an example of sequential torque direction change of a front-wheel torque command and a rear-wheel torque command and gradient (change rate) limit correction in zero-crossing according to an exemplary embodiment of the present disclosure.

As shown in FIG. 4, in a case where it is determined that there is a change request of the direction of the required torque from vehicle driving information such as an accelerator position sensor value, the controller 20 is configured to perform control so that the front-wheel torque and rear-wheel torque sequentially pass through the backlash band.

In the exemplary embodiment of FIG. 2, the sequential torque direction change is performed, but while each torque command passes through the backlash band, the gradient limit correction for the torque command is not performed. On the other hand, in the exemplary embodiment of FIG. 4, the gradient of the torque command passing through the backlash band is limited along with the sequential torque direction change.

As shown in FIG. 4, in a case where there is the change request of the direction of the required torque from the vehicle driving information such as an accelerator position sensor value, the controller 20 is configured to perform control so that the front-wheel torque and rear-wheel torque sequentially pass through the backlash band, and accordingly, the front-wheel torque and the rear-wheel torque perform zero-crossing.

Here, in the zero-crossing of the front-wheel torque command, front-wheel torque command correction for limiting the change rate (gradient) of the front-wheel torque command to a predetermined maximum allowable change rate (maximum allowable gradient) is performed, and in the zero-crossing of the rear-wheel torque command, rear-wheel torque command correction for limiting the change rate of the rear-wheel torque command to a predetermined maximum allowable change rate is performed. Here, the correction for limiting the change rate of the torque command performing zero-crossing is correction for reducing the backlash shock.

In the zero-crossing of the front-wheel torque command, a backlash shock reduction control process of limiting the change rate (gradient) of the distributed front-wheel torque command is performed using a change rate limiter or the like, instead of direct application of the front-wheel torque command that does not take backlash shock into account, that is, the front-wheel torque command distributed and determined from the required torque according to the front and rear-wheel torque distribution logic.

The distributed front-wheel torque command is limited to the preset maximum allowable change rate (first maximum allowable change rate) to be changed smoothly, and accordingly, the front-wheel torque command taking backlash shock into account may be used.

Similarly, in the zero-crossing of the rear-wheel torque command, a backlash shock reduction control process of limiting the change rate (gradient) of the distributed rear-wheel torque command is performed using a change rate limiter or the like, instead of direct application of the rear-wheel torque command that does not take backlash shock into account, that is, the rear-wheel torque command distributed and determined from the required torque according to the front and rear-wheel torque distribution logic.

The distributed rear-wheel torque command is limited to the preset maximum allowable change rate (second maximum allowable change rate) to be changed smoothly, and accordingly, the rear-wheel torque command taking backlash shock into account may be used.

Referring to FIG. 4, it may be seen that the change rate of the front-wheel torque command is limited from a time point at which the front-wheel torque command passes through 0 torque to a time point at which the front-wheel torque command reaches a set torque, and the change rate of the rear-wheel torque command is limited from a time point at which the rear-wheel torque command passes 0 torque to a time point at which the rear-wheel torque command reaches a set torque.

As another exemplary embodiment of the present disclosure, when one of the front-wheel torque and the rear-wheel torque passes through the backlash band where the change rate is limited, torque compensation control for offsetting the effect of the change rate limit is performed on the other thereof, making it possible to prevent the backlash of the drive system from affecting the overall acceleration of the vehicle.

That is, while limiting the change rate (gradient) of the torque command of one of the front-wheel drive system and the rear-wheel drive system that passes through the backlash band to the set maximum allowable change rate, the torque command of the other drive system is determined as a torque value so that the sum of the two torque commands can satisfy the required torque.

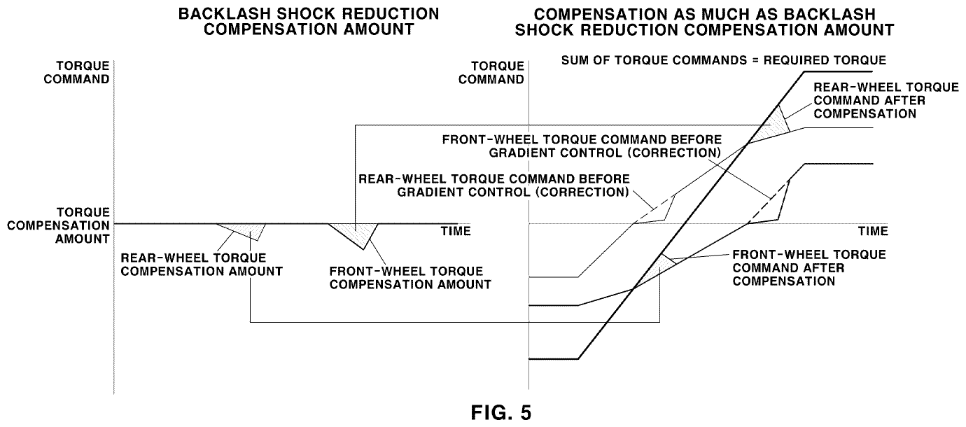

The present exemplary embodiment will be described in more detail with reference to FIG. 5. FIG. 5 is a diagram showing an example of torque correction values (“rear-wheel torque compensation amount” and “front-wheel torque compensation amount”) for backlash shock reduction and torque correction using the torque correction values according to an exemplary embodiment of the present disclosure.

In the exemplary embodiment of FIG. 5, as in the exemplary embodiments of FIGS. 2 and 4, the front-wheel torque command and the rear-wheel torque command are controlled to pass through the backlash band sequentially rather than simultaneously.

However, in the exemplary embodiment of FIG. 5, in a case where one of the front-wheel drive system and the rear-wheel drive system passes through the backlash band, that is, in a case where one of the front-wheel torque command and the rear-wheel torque command passes through the backlash band, torque correction values (in FIG. 5, “rear-wheel torque compensation amount” and “front-wheel torque compensation amount”) are determined using the motor torque command of the drive system passing through the backlash band, and accordingly, the motor torque command of the drive system that does not pass through the backlash band is compensated as much as the torque correction value.

That is, in the exemplary embodiment of FIG. 5, during the sequential backlash passage and zero-crossing of the drive system torque, to prevent torque discontinuity and discontinuity in actual vehicle acceleration from occurring since the sum of the front-wheel torque and rear-wheel torque does not satisfy the required torque, the rear-wheel torque is compensated in the zero-crossing of the front wheels, or the front-wheel torque is compensated in the zero-crossing of the rear wheels.

In the exemplary embodiment of the present disclosure, in a case where a raw torque command distributed from the required torque is corrected by the change rate limit, the torque correction value (torque compensation amount) refers to the amount of torque corrected by the change rate limit from the raw torque command. A difference between the raw torque command and the torque command corrected by the change rate limit is the torque correction value.

In the exemplary embodiment of FIG. 5, in a case where the front-wheel torque command passes through the backlash band to perform zero-crossing, the controller 20 is configured to determine and corrects the change rate (gradient) of the front-wheel torque command to become a value limited to the maximum allowable change rate, and compensates for the rear-wheel torque command with the torque correction value determined using the front-wheel torque command.

The torque correction value in the zero-crossing of the front-wheel torque command may be determined as a difference value between the front-wheel torque command distributed from the required torque according to the front and rear-wheel torque distribution logic and having no change rate limit (front-wheel torque command that does not take backlash shock into account in FIG. 2), and the front-wheel torque command (front-wheel torque command that takes backlash shock into account in FIG. 4), the torque change rate of which is limited to the maximum allowable change rate.

Accordingly, the front-wheel torque command is determined as a value subjected to the change rate limit, at the same time, compensation is performed for adding the determined torque correction value to the rear-wheel torque command distributed according to the front and rear-wheel torque distribution logic, and the compensated rear-wheel torque command is determined as a final rear-wheel torque command.

Similarly, in a case where the rear-wheel torque command passes through the backlash band to perform zero-crossing, the controller 20 is configured to determine and corrects the change rate (gradient) of the rear-wheel torque command to become a value limited to the maximum allowable change rate, and compensates for the front-wheel torque command with the torque correction value determined using the rear-wheel torque command.

The torque correction value in the zero-crossing of the rear-wheel torque command may be determined as a difference value between the rear-wheel torque command distributed from the required torque according to the front and rear-wheel torque distribution logic and having no change rate limit (rear-wheel torque command that does not take backlash shock into account in FIG. 2), and the rear-wheel torque command (rear-wheel torque command that takes backlash shock into account in FIG. 4), the torque change rate of which is limited to the maximum allowable change rate.

Accordingly, the rear-wheel torque command is determined as a value subjected to the change rate limit, at the same time, compensation is performed for adding the determined torque correction value to the front-wheel torque command distributed according to the front and rear-wheel torque distribution logic, and the compensated front-wheel torque command is determined as a final front-wheel torque command.

In the present way, the controller 20 finally is configured to determine the front-wheel torque command and the rear-wheel torque command for backlash shock reduction, enables the sum of the finally determined front-wheel torque command and rear-wheel torque command to follow the required torque, and is configured to control the operations of the front-wheel motor 31 and the rear-wheel motor 41 according to the finally determined front-wheel torque command and rear-wheel torque command.

By constantly satisfying the required torque by the sum of the front-wheel torque and the rear-wheel torque, it is possible to minimize a drivability impact due to the backlash in the drive system while the front-wheel torque and the rear-wheel torque sequentially pass through the backlash band and perform zero-crossing.

As described above with reference to FIG. 2, in a case where the torque distribution ratio is determined as a value corresponding to the required torque (entire torque command before distribution, sum of front and rear-wheel torque commands after distribution), the required torque is distributed to the front-wheel torque command and the rear-wheel torque command according to the front-wheel torque distribution rate and the rear-wheel torque distribution rate corresponding to the determined torque distribution ratio, and the zero-crossing time point of each drive system torque is determined according to the torque distribution rate of each torque command.

That is, in a case where the torque distribution rate of one of the front-wheel torque command and the rear-wheel torque command is 0, the torque command with the torque distribution rate of 0 performs zero-crossing, and a time point at which the torque distribution rate is 0 is the zero-crossing time point of the drive system torque determined based on the required torque.

According to another exemplary embodiment of the present disclosure, zero-crossing time points of the front-wheel torque command and the rear-wheel torque command are determined based on the required torque, which will be referred to as follows.

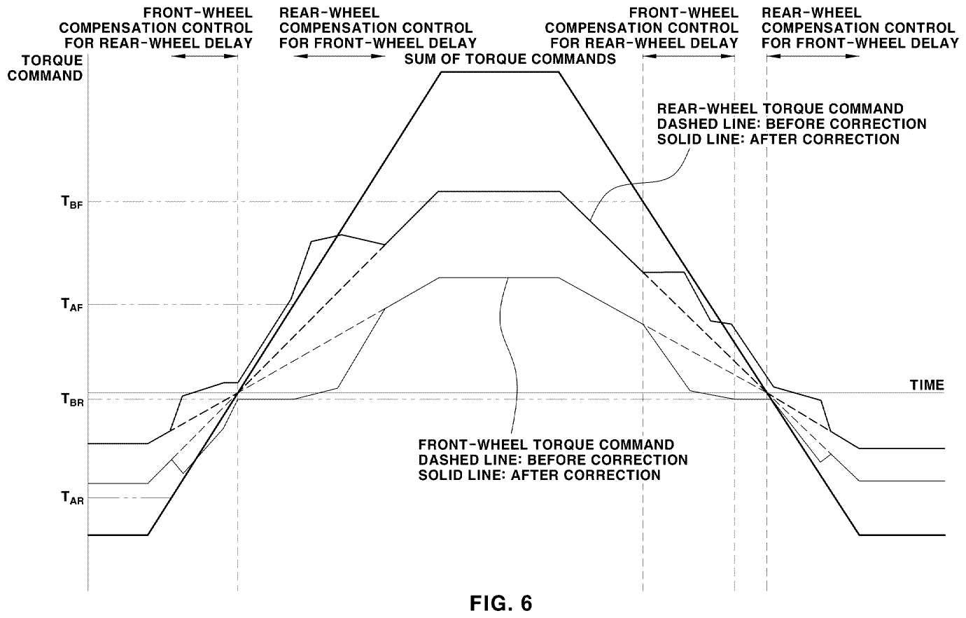

FIG. 6 is a diagram illustrating a method of determining zero-crossing time points of a front-wheel torque command and a rear-wheel torque command based on required torque according to an exemplary embodiment of the present disclosure. FIG. 6 shows the required torque as well as the front-wheel torque command and rear-wheel torque command distributed from the required torque.

In the exemplary embodiment of FIG. 6, the sum of the front-wheel torque command and the rear-wheel torque command satisfies the required torque in an entire torque section. In other words, the front-wheel torque command and the rear-wheel torque command are determined as values so that the sum thereof can satisfy the required torque. Accordingly, the required torque may be the entire torque command before distribution, and also, the sum of the front and rear-wheel torque commands after distribution.

A front-wheel torque command and a rear-wheel torque command indicated by dashed lines in FIG. 6 are front-wheel and rear-wheel torque commands according to the related art in which the direction changes of the two torque commands are performed simultaneously, and are typical front-wheel and rear-wheel torque commands distributed from required torque according to the typical front and rear-wheel torque distribution logic, in which the backlash shock is not taken into consideration.

In the exemplary embodiment of FIG. 6, the controller 20 may set a first threshold (T_{AR}), a second threshold (T_{BR}), a third threshold (T_{AF}), and a fourth threshold (T_{BF}), respectively, which are predetermined values, based on the required torque.

The first threshold (T_{AR}) and the second threshold (T_{BR}) may be set as torque values in the negative (−) direction, which is the motor regenerative direction, and the third threshold (T_{AF}) and the fourth threshold (T_{BF}) may be set as torque values in the positive (+) direction, which is the motor driving direction thereof.

Furthermore, as the torque values in the negative (−) direction, the first threshold (T_{AR}) and the second threshold (T_{BR}) may be set so that an absolute value (|T_{AR}|) of the first threshold is greater than an absolute value (|T_{BR}|) of the second threshold (“|T_{AR}|>|T_{BR}|” and “T_{AR}<T_{BR}”). Furthermore, as the torque values in the positive (+) direction, the fourth threshold (T_{BF}) may be set to be a larger value than the third threshold (T_{AF}) (T_{BF}>T_{AF}).

Here, in a case where the required torque gradually increases from a value below the first threshold (T_{AR}) and reaches the first threshold (T_{AR}), the zero-crossing control of the rear-wheel torque command begins. Accordingly, until the required torque increases to reach 0 torque, the zero-crossing control of the rear-wheel torque command is performed. Furthermore, the zero-crossing control of the rear-wheel torque command is completed at a time point at which the required torque reaches 0.

That is, in a case where the required torque is greater than or equal to the first threshold (T_{AR}), the zero-crossing of the rear-wheel torque command is performed. Here, the zero-crossing of the rear-wheel torque command corresponds to a torque control process of switching from torque in the negative (−) direction, which is the motor regenerative direction, to torque in the positive (+) direction, which is the motor driving direction thereof.

In the above process, until the required torque reaches the second threshold (T_{BR}), the front-wheel torque command is determined as a value obtained by subtracting the rear-wheel torque command from the required torque, and accordingly, the required torque is satisfied by the sum of the front-wheel torque command and the rear-wheel torque command.

Furthermore, in a case where the required torque gradually increases after reaching the second threshold (T_{BR}), direction change of the required torque and zero-crossing are performed, and then, the front-wheel torque command is determined as the second threshold (T_{BR}) until the required torque reaches the third threshold (T_{AF}).

Here, the rear-wheel torque command is determined as a value obtained by subtracting the second threshold (T_{BR}), which is the value of the front-wheel torque command, from the required torque, so that the sum of the front-wheel torque command and the rear-wheel torque command follows the required torque.

Accordingly, the zero-crossing control of the front-wheel torque command starts from a time point at which the required torque reaches the third threshold (T_{AF}), and after a certain time period, zero-crossing of the front-wheel torque command is completed.

In other words, in a case where the required torque is greater than or equal to the third threshold (T_{AF}), the zero-crossing of the front-wheel torque command is performed. Here, the zero-crossing of the front-wheel torque command corresponds to a torque control process of switching from torque in the negative (−) direction, which is the motor regenerative direction, to torque in the positive (+) direction, which is the motor driving direction thereof.

Accordingly, the front-wheel torque command that has completed the zero-crossing changes to a torque command value distributed from the required torque according to the typical front and rear-wheel torque distribution logic. After the front-wheel torque command changes to the torque command value distributed according to the typical front and rear-wheel torque distribution logic, the rear-wheel torque command is also determined as a torque command value distributed according to the typical front and rear-wheel torque distribution logic.

In the above-described embodiment of the present disclosure, the second threshold (T_{BR}) is a front-wheel maximum torque threshold set to avoid the backlash band of the front-wheel torque command. Until the required torque reaches the second threshold (T_{BR}), which is the front-wheel maximum torque threshold, the direction change and zero-crossing of the required torque are performed, and then, the required torque reaches the third threshold (T_{BR}), the front-wheel torque command is determined as the second threshold value (T_{BR}), which is the front-wheel maximum torque threshold, so as not to enter the backlash band.

As described above, the controller 20 may respectively set the backlash band of the front-wheel drive system and the backlash band of the rear-wheel drive system to a torque range including a lower limit threshold, which is a negative (−) value, and an upper limit threshold, which is a positive (+) value. That is, the backlash band may be set to a torque range including 0.

In the exemplary embodiment of the present disclosure, the second threshold (T_{BR}) may be set as a torque value outside the backlash band, which is a torque band where the backlash may occur in the front-wheel drive system, and the second threshold (T_{BR}) may be set as a value smaller than the lower limit threshold of the backlash band of the front-wheel drive system.

Furthermore, the zero-crossing control of the rear-wheel torque command is performed to determine the torque value of the rear-wheel torque command so that the change rate of the rear-wheel torque command is a preset maximum allowable change rate, that is, to adjust and limit the change rate of the rear-wheel torque command to the maximum allowable change rate.

Similarly, the zero-crossing control of the front-wheel torque command is performed to determine the torque value of the front-wheel torque command so that the change rate of the front-wheel torque command is a preset maximum allowable change rate, that is, to adjust and limit the change rate of the front-wheel torque command to the maximum allowable change rate.

Accordingly, in a case where the required torque gradually decreases from a value exceeding the fourth threshold (T_{BF}) and reaches the fourth threshold (T_{BF}), the zero-crossing control of the front-wheel torque command begins. Accordingly, in a case where the required torque decreases to reach the second threshold (T_{BR}), the zero-crossing control of the rear-wheel torque command begins.

That is, in a case where the required torque is equal to or lower than the fourth threshold (T_{BF}), the zero-crossing of the front-wheel torque command is performed. Here, the zero-crossing of the front-wheel torque command corresponds to a torque control process of switching from torque in the positive (+) direction, which is the motor driving direction, to torque in the negative (−) direction, which is the motor regenerative direction thereof.

For the zero-crossing of the front-wheel torque command, in a case where the required torque decreases to reach the fourth threshold (T_{BF}), the controller 20 reduces the front-wheel torque command to a set zero-crossing start torque value, and then reduces the front-wheel torque command from the zero-crossing start torque value to the second threshold (T_{BR}) at the set maximum allowable change rate.

Accordingly, in a case where the front-wheel torque command reaches the second threshold (T_{BR}), even if the required torque decreases, only the rear-wheel torque command is reduced, and the front-wheel torque command is maintained at the second threshold (T_{BR}). Furthermore, at a time point at which the required torque reaches the second threshold (T_{BR}), the controller 20 starts the zero-crossing control of the rear-wheel torque command.

That is, in a case where the required torque is equal to or lower than the second threshold (T_{BR}), the zero-crossing of the rear-wheel torque command is performed. Here, the zero-crossing of the rear-wheel torque command corresponds to a torque control process of switching from torque in the positive (+) direction, which is the motor driving direction, to torque in the negative (−) direction, which is the motor regenerative direction thereof.

Accordingly, the rear-wheel torque command that has completed the zero-crossing changes to a torque command value distributed from the required torque according to the typical front and rear-wheel torque distribution logic. After the rear-wheel torque command changes to the torque command value distributed according to the typical front and rear-wheel torque distribution logic, the front-wheel torque command is also determined as a torque command value distributed according to the typical front and rear-wheel torque distribution logic.

In the process where the required torque decreases as described above, the sum of the front-wheel torque command and the rear-wheel torque command follows the required torque. Furthermore, in the process where the required torque decreases, the zero-crossing control of the rear-wheel torque command is performed to determine the torque value of the rear-wheel torque command so that the change rate of the rear-wheel torque command is a preset maximum allowable change rate, that is, to adjust and limit the change rate of the rear-wheel torque command to the maximum allowable change rate.

Similarly, the zero-crossing control of the front-wheel torque command also includes a process of determining the torque value of the rear-wheel torque command so that the change rate of the front-wheel torque command is a preset maximum allowable change rate, that is, a process of limiting and adjusting the change rate of the front-wheel torque command from the zero-crossing start torque value to the second threshold (T_{BR}) at the set maximum allowable change rate.

As described above, in the exemplary embodiment of FIG. 6, the sequential zero-crossing time points of the front-wheel torque command and the rear-wheel torque command are determined based on the required torque. In the exemplary embodiment of FIG. 6, while the zero-crossing correction is performed on one of the front-wheel torque command and the rear-wheel torque command, torque compensation is performed on the other torque command.

Here, a torque compensation amount is determined as a difference value between a corrected drive system side torque command and a non-corrected drive system side torque command in the zero-crossing process, as described with reference to FIG. 5, and the sum of the front-wheel torque command and the rear-wheel torque command constantly follows the required torque regardless of whether zero-crossing is performed or not.

A method of sequentially performing the zero-crossing of the front-wheel torque command and the rear-wheel torque command according to the exemplary embodiment of FIG. 6 will be described as follows.

In a case where the required torque determined in real time gradually increases from torque in the vehicle deceleration direction and switches to torque in the vehicle acceleration direction, the controller 20 is first configured to perform the zero-crossing of the rear-wheel torque command, and then is configured to perform the zero-crossing of the front-wheel torque command.

To the present end, the controller 20 sets a threshold 1 (T_{AR}, the above-mentioned first threshold), which is a torque with a negative (−) value as the torque in the vehicle deceleration direction, and sets a threshold 2 (T_{AF}, the above-mentioned third threshold), which is a positive (+) value as the torque in the vehicle acceleration direction thereof.

Here, the controller 20 starts and is configured to perform control for the zero-crossing of the rear-wheel torque command at a time point at which the required torque increases from the torque in the vehicle deceleration direction and reaches the threshold 1 (T_{AR}), and starts and is configured to perform control for the zero-crossing of the front-wheel torque command at a time point at which the required torque switches to the torque in the vehicle acceleration direction, and increases to reach the threshold 2 (T_{AF}).

Furthermore, in a case where the required torque determined in real time gradually decreases from torque in the vehicle acceleration direction and switches to torque in the vehicle deceleration direction, the controller 20 is first configured to perform the zero-crossing of the front-wheel torque command, and then is configured to perform the zero-crossing of the rear-wheel torque command.

To the present end, the controller 20 sets a threshold 3 (T_{BF}, the above-mentioned fourth threshold), which is a torque with a positive (+) value as the torque in the vehicle acceleration direction, and sets a threshold 4 (T_{BR}, the above-mentioned second threshold), which is a torque with a negative (−) value as the torque in the vehicle deceleration direction thereof.

Here, the controller 20 starts and is configured to perform control for the zero-crossing of the front-wheel torque command at a time point at which the required torque decreases from the torque in the vehicle acceleration direction and reaches the threshold 3 (T_{BF}), and starts and is configured to perform control for the zero-crossing of the rear-wheel torque command at a time point at which the required torque switches to the torque in the vehicle deceleration direction, and decreases to reach the threshold 4 (T_{BR}).

As another method of determining the sequential zero-crossing time points of the front-wheel torque command and the rear-wheel torque command, a method of determining, according to a completion time point of one of the front-wheel torque command and the rear-wheel torque command, a zero-crossing execution time point of the other one thereof may be used.

In other words, rather than determining the time point to perform the zero-crossing based on only the required torque and the thresholds, in a case where the required torque increases or decreases linearly, the zero-crossing of one of the front-wheel torque command and the rear-wheel torque command is first performed, and based on the time point at which the preceding zero-crossing is completed, the zero-crossing time point of the other one thereof is determined.

As an exemplary embodiment of the present disclosure, in a case where a preset time elapses after the preceding zero-crossing is completed, the controller 20 is configured to determine the front-wheel torque command and the rear-wheel torque that follow the required torque according to change in the required torque to perform and complete the subsequent zero-crossing. That is, in a case where the preset time elapses after the zero-crossing of one of the front-wheel torque command and the rear-wheel torque command is completed, the other zero-crossing is performed.

Furthermore, in the exemplary embodiment of the present disclosure, during the sequential zero-crossing of the front-wheel torque command and the rear-wheel torque command, in compensating for the influence due to a change rate limit (gradient limit) of a drive system side torque command that is configured to perform zero-crossing with respect to a drive system side torque command that does not perform zero-crossing, a method for preventing the drive system side torque command from entering the backlash band after the compensation may be used.

As described above, in an exemplary embodiment of the present disclosure, in a case where there is a change request of the direction of the required torque, the required torque passes through the backlash band and zero-crossing is performed. Here, the sequential change direction, the sequential passing through the backlash band, and the sequential zero-crossing of the front-wheel torque command and the rear-wheel torque command that satisfy the required torque are performed.

In the description of the present disclosure, the entry into the backlash band means that a torque value of a corresponding torque command enters the backlash band and becomes a torque value within the backlash band. Furthermore, the passing through the backlash band means that the torque value of the torque command enters the backlash band from the outside of the backlash band and then continues to increase or decrease to deviate from the backlash band again.

A main purpose of the sequential zero-crossing is to offset the influence of the change rate limit (gradient limit) of the drive system torque command that performs zero-crossing by compensation of the drive system torque command that does not perform zero-crossing.

However, in a case where a compensation value for the drive system torque command that does not perform zero-crossing to satisfy the required torque is determined as a torque value that causes the backlash, the purpose of performing the sequential zero-crossing cannot be achieved.

Accordingly, in a case where the compensation result of the drive system torque command that does not perform zero-crossing enters the backlash band of the corresponding drive system, the change rate (gradient) of the required torque or the size of the torque correction value (torque compensation amount) is limited so that the compensation result of the drive system torque command becomes a value for avoiding zero-crossing.

There are four cases in which the compensation result of the drive system torque command does not enter the backlash band of the corresponding drive system and the compensated drive system torque command avoids zero-crossing.

This is a case where the rear-wheel torque command is maintained in a torque band in the regenerative direction (the vehicle deceleration direction) and then switches to a torque band in the driving direction (the vehicle acceleration direction), so that the zero-crossing of the rear-wheel torque command is performed.

During the zero-crossing of the rear-wheel torque, correction for limiting the gradient (change rate) of the rear-wheel torque is performed, and an effect of the present correction is compensated for in the front-wheel torque. In other words, the upward gradient (increase rate) of the rear-wheel torque is limited by the zero-crossing characteristics, and at the same time, the front-wheel torque in the torque band in the regenerative direction in a non-zero-crossing state is increased by the torque compensation amount, making it possible to follow the required torque by the sum of the front-wheel torque and the rear-wheel torque.

In the instant case, to prevent the zero-crossing of the front-wheel torque, the front-wheel torque before compensation is determined to maintain regenerative braking torque which is greater than or equal to the torque compensation amount. Here, the torque compensation amount is a difference value between the rear-wheel torque before limiting the gradient and the rear-wheel torque after limiting the gradient.

In other words, the torque compensation amount is a difference value between the rear-wheel torque command, which is distributed from the required torque and has no gradient limit (change rate limit), and the rear-wheel torque command with the torque gradient limited to the maximum allowable gradient (maximum allowable change rate).

The torque compensation amount may also be determined as a difference value between a torque sum that represents the sum of the rear-wheel torque command before gradient limitation and the front-wheel torque command before compensation, and a torque sum that represent the sum of the rear-wheel torque command after gradient limitation and the front-wheel torque command before compensation.

2) This is a case where the front-wheel torque command is maintained in a torque band in the regenerative direction and then switches to a torque band in the driving direction, so that the zero-crossing of the front-wheel torque command is performed.

During the zero-crossing of the front-wheel torque, correction for limiting the gradient (change rate) of the front-wheel torque is performed, and an effect of the present correction is compensated for in the rear-wheel torque. In other words, the upward gradient (increase rate) of the front-wheel torque is limited by the zero-crossing characteristics, and at the same time, the rear-wheel torque in the torque band in the driving direction in a zero-crossing-completed state is increased by the torque compensation amount, making it possible to follow the required torque by the sum of the front-wheel torque and the rear-wheel torque.

Here, since there is already a sufficient room for the rear-wheel torque increase, the rear-wheel torque before compensation is set to be in the torque band in the driving direction thereof.

3) This is a case where the front-wheel torque command is maintained in a torque band in the driving direction (the vehicle acceleration direction) and then switches to a torque band in the regenerative direction (the vehicle deceleration direction), so that the zero-crossing of the front-wheel torque command is performed.

During the zero-crossing of the front-wheel torque, correction for limiting the gradient (change rate) of the front-wheel torque is performed, and the influence of the present correction is compensated for in the rear-wheel torque. In other words, the downward gradient (decrease rate) of the front-wheel torque is limited by the zero-crossing characteristics, and at the same time, the rear-wheel torque in the torque band in the driving direction in a non-zero-crossing state is decreased by the torque compensation amount, making it possible to follow the required torque by the sum of the front-wheel torque and the rear-wheel torque.

In the instant case, to prevent the zero-crossing of the rear-wheel torque, the rear-wheel torque before compensation is determined to maintain driving torque which is greater than or equal to the torque compensation amount. Here, the torque compensation amount is a difference value between the front-wheel torque before limiting the gradient and the front-wheel torque after limiting the gradient.

In other words, the torque compensation amount is a difference value between the front-wheel torque command, which is distributed from the required torque and has no gradient limit (change rate limit), and the front-wheel torque command with the torque gradient limited to the maximum allowable gradient (maximum allowable change rate).

The torque compensation amount may also be determined as a difference value between a torque sum that represents the sum of the front-wheel torque command before gradient limitation and the rear-wheel torque command before compensation, and a torque sum that represents the sum of the front-wheel torque command after gradient limitation and the rear-wheel torque command before compensation.

4) This is a case where the rear-wheel torque command is maintained in a torque band in the driving direction and then switches to a torque band in the regenerative direction, so that the zero-crossing of the rear-wheel torque command is performed.

During the zero-crossing of the rear-wheel torque, correction for limiting the gradient (change rate) of the rear-wheel torque is performed, and the influence of the present correction is compensated for in the front-wheel torque. In other words, the downward gradient (decrease rate) of the rear-wheel torque is limited by the zero-crossing characteristics, and at the same time, the front-wheel torque in the torque band in the regenerative direction in a zero-crossing-completed state is decreased by the torque compensation amount, making it possible to follow the required torque by the sum of the front-wheel torque and the rear-wheel torque.

Here, since there is already a sufficient room for the front-wheel torque decrease, the front-wheel torque before compensation is set to be in the torque band in the regenerative direction thereof.

The torque control system for the drive system and method therefor according to the exemplary embodiments of the present disclosure have been described in detail. As described above, according to an exemplary embodiment of the present disclosure, by sequentially changing the directions of the front-wheel torque and the rear-wheel torque, it is possible to alleviate the backlash of the drive system in the electric vehicle, and to reduce the backlash vibration, improving drivability of the vehicle.

Furthermore, according to an exemplary embodiment of the present disclosure, by solving the backlash shock problem, it is possible to improve the acceleration/deceleration responsiveness and longitudinal driving performance of the vehicle.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A torque control system for a drive system of an electric vehicle, the torque control system comprising:
a controller that generates a front-wheel torque command and a rear-wheel torque command including torque values distributed from a required torque for vehicle driving;
a front-wheel motor operatively connected to the controller, wherein operation of the front-wheel motor is controlled according to the front-wheel torque command generated and output by the controller; and
a rear-wheel motor operatively connected to the controller, wherein operation of the front-wheel motor is controlled according to the rear-wheel torque command generated and output by the controller,
wherein the controller is configured to determine whether there is a change request of a direction of the required torque for the vehicle driving, to determine, in response that the controller concludes that there is the change request of the direction of the required torque, the front-wheel torque command and the rear-wheel torque command determined from the required torque as values for sequential zero-crossing while the required torque determined in real time changes while performing zero-crossing of passing through 0 torque for direction change, and to determine a time point at which the front-wheel torque command performs the zero-crossing and a time point at which the rear-wheel torque command performs the zero-crossing based on the required torque determined in real time.

2. The system of claim 1, wherein the controller is further configured to determine the front-wheel torque command and the rear-wheel torque command determined from the required torque while the required torque changes, as values so that a torque sum of the front-wheel torque command and the rear-wheel torque command satisfies the required torque.

3. The system of claim 1, wherein the controller is further configured to perform torque correction for limiting a change rate of the front-wheel torque command to a preset first maximum allowable change rate in the zero-crossing of the front-wheel torque command, and to perform torque correction for limiting a change rate of the rear-wheel torque command to a preset second maximum allowable change rate in the zero-crossing of the rear-wheel torque command.

4. The system of claim 3, wherein the controller is further configured to perform, while performing the torque correction for limiting the change rate of the front-wheel torque command to the preset first maximum allowable change rate, torque compensation for the rear-wheel torque command distributed from the required torque so that a sum of the front-wheel torque command, the change rate of which is limited, and the rear-wheel torque command distributed from the required torque satisfies the required torque.

5. The system of claim 3, wherein the controller is further configured to perform, while performing the torque correction for limiting the change rate of the rear-wheel torque command to the preset second maximum allowable change rate, torque compensation for the front-wheel torque command distributed from the required torque so that a sum of the rear-wheel torque command, the change rate of which is limited, and the front-wheel torque command distributed from the required torque satisfies the required torque.

6. The system of claim 1,
wherein the controller is further configured to set a front-wheel torque distribution rate and a rear-wheel torque distribution rate as values that vary depending on the required torque, and
wherein, in response that the front-wheel torque distribution rate corresponding to the required torque determined in real time is 0, a torque value of the front-wheel torque command becomes 0 and the zero-crossing of passing through 0 torque is performed in the front-wheel torque command, and in response that the rear-wheel torque distribution rate corresponding to the required torque determined in real time is 0, a torque value of the rear-wheel torque command becomes 0 and the zero-crossing passing through 0 torque is performed in the rear-wheel torque command.

7. The system of claim 1, wherein, in response that the required torque determined in real time increases from torque in a vehicle deceleration direction and switches to torque in a vehicle acceleration direction, the controller is further configured to perform the zero-crossing of the rear-wheel torque command, and then to perform the zero-crossing of the front-wheel torque command.

8. The system of claim 7, wherein the controller sets a first threshold, which is a torque with a negative (−) value, as the torque in the vehicle deceleration direction, and sets a second threshold, which is a torque with a positive (+) value, as the torque in the vehicle acceleration direction, starts and performs control for the zero-crossing of the rear-wheel torque command at a time point at which the required torque increases from the torque in the vehicle deceleration direction and reaches the first threshold, and starts and performs control for the zero-crossing of the front-wheel torque command at a time point at which the required torque switches to the torque in the vehicle acceleration direction and increases to reach the second threshold.

9. The system of claim 1, wherein, in response that the required torque determined in real time decreases from torque in a vehicle acceleration direction and switches to torque in a vehicle deceleration direction, the controller is further configured to perform the zero-crossing of the front-wheel torque command, and then to perform the zero-crossing of the rear-wheel torque command.

10. The system of claim 9, wherein the controller sets a third threshold, which is a torque with a positive (+) value, as the torque in the vehicle acceleration direction, and sets a fourth threshold, which is a torque with a negative (−) value, as the torque in the vehicle deceleration direction, starts and performs control for the zero-crossing of the front-wheel torque command at a time point at which the required torque decreases from the torque in the vehicle acceleration direction and reaches the third threshold, and starts and performs control for the zero-crossing of the rear-wheel torque command at a time point at which the required torque switches to the torque in the vehicle deceleration direction and decreases to reach the fourth threshold.

11. The system of claim 1, wherein, in response that the required torque determined in real time increases or decreases linearly, after a preset time elapses after the zero-crossing of one of the front-wheel torque command and the rear-wheel torque command is completed, the controller is further configured to perform the zero-crossing of the other of the front-wheel torque command and the rear-wheel torque command.

12. A torque control method for a drive system of an electric vehicle, the torque control method comprising:
determining, by a controller, whether there is a change request of a direction of a required torque for vehicle driving,
determining, by the controller, in response that the controller concludes that there is the change request of the direction of the required torque, a front-wheel torque command and a rear-wheel torque command including torque values distributed from the required torque determined in real time while the required torque determined in real time changes while performing zero-crossing of passing through 0 torque to change the direction, and
controlling, by the controller, operations of a front-wheel motor and a rear-wheel motor operatively connected to the controller, according to the determined front-wheel torque command and rear-wheel torque command,
wherein the controller is further configured to determine the front-wheel torque command and the rear-wheel torque command determined from the required torque as values for sequential zero-crossing while the required torque changes while performing the zero-crossing for direction change, and is configured to determine a time point at which the front-wheel torque command performs the zero-crossing and a time point at which the rear-wheel torque command performs the zero-crossing based on the required torque determined in real time.

13. The method of claim 12, wherein the controller is further configured to determine the front-wheel torque command and the rear-wheel torque command determined from the required torque while the required torque changes, as values so that a torque sum of the front-wheel torque command and the rear-wheel torque command satisfies the required torque.

14. The method of claim 12, wherein the controller is further configured to perform torque correction for limiting a change rate of the front-wheel torque command to a preset first maximum allowable change rate in the zero-crossing of the front-wheel torque command, and to perform torque correction for limiting a change rate of the rear-wheel torque command to a preset second maximum allowable change rate in the zero-crossing of the rear-wheel torque command.

15. The method of claim 12,
wherein the controller is further configured to set a front-wheel torque distribution rate and a rear-wheel torque distribution rate as values that vary depending on the required torque, and
wherein, in response that the front-wheel torque distribution rate corresponding to the required torque determined in real time is 0, a torque value of the front-wheel torque command becomes 0 and the zero-crossing of passing through 0 torque is performed in the front-wheel torque command, and in response that the rear-wheel torque distribution rate corresponding to the required torque determined in real time is 0, a torque value of the rear-wheel torque command becomes 0 and the zero-crossing passing through 0 torque is performed in the rear-wheel torque command.

16. The method of claim 12, wherein, in response that the required torque determined in real time increases from torque in a vehicle deceleration direction and switches to torque in a vehicle acceleration direction, the controller is further configured to perform the zero-crossing of the rear-wheel torque command, and then to perform the zero-crossing of the front-wheel torque command.

17. The method of claim 16, wherein the controller sets a first threshold, which is a torque with a negative (−) value, as the torque in the vehicle deceleration direction, and sets a second threshold, which is a torque with a positive (+) value, as the torque in the vehicle acceleration direction, starts and performs control for the zero-crossing of the rear-wheel torque command at a time point at which the required torque increases from the torque in the vehicle deceleration direction and reaches the first threshold, and starts and performs control for the zero-crossing of the front-wheel torque command at a time point at which the required torque switches to the torque in the vehicle acceleration direction and increases to reach the second threshold.

18. The method of claim 12, wherein, in response that the required torque determined in real time decreases from torque in a vehicle acceleration direction and switches to torque in a vehicle deceleration direction, the controller is further configured to perform the zero-crossing of the front-wheel torque command, and then to perform the zero-crossing of the rear-wheel torque command.

19. The method of claim 18, wherein the controller sets a third threshold, which is a torque with a positive (+) value, as the torque in the vehicle acceleration direction, and sets a fourth threshold, which is a torque with a negative (−) value, as the torque in the vehicle deceleration direction, starts and performs control for the zero-crossing of the front-wheel torque command at a time point at which the required torque decreases from the torque in the vehicle acceleration direction and reaches the third threshold, and starts and performs control for the zero-crossing of the rear-wheel torque command at a time point at which the required torque switches to the torque in the vehicle deceleration direction and decreases to reach the fourth threshold.

20. The method of claim 12, wherein, in response that the required torque determined in real time increases or decreases linearly, after a preset time elapses after the zero-crossing of one of the front-wheel torque command and the rear-wheel torque command is completed, the controller is further configured to perform the zero-crossing of the other of the front-wheel torque command and the rear-wheel torque command.
